(19) United States
(12) Patent Application Publication
(10) Pub. No.: US 2012/0148101 A1
(43) Pub. Date: Jun. 14, 2012

(54) METHOD AND APPARATUS FOR EXTRACTING TEXT AREA, AND AUTOMATIC RECOGNITION SYSTEM OF NUMBER PLATE USING THE SAME

(75) Inventors: Young Woo YOON, Daejeon (KR); Ho Sub Yoon, Daejeon (KR); Kyu Dae Ban, Gyeongsangbuk-do (KR); Jae Yeon Lee, Daejeon (KR); Do Hyung Kim, Daejeon (KR); Su Young Chi, Daejeon (KR); Jae Hong Kim, Daejeon (KR); Joo Chan Sohn, Daejeon (KR)

(73) Assignee: ELECTRONICS AND TELECOMMUNICATIONS RESEARCH INSTITUTE, Daejeon (KR)

(21) Appl. No.: 13/325,035

(22) Filed: Dec. 13, 2011

(30) Foreign Application Priority Data
Dec. 14, 2010 (JP) 10-2010-0127723

(51) Int. Cl. G06K 9/18

(52) U.S. Cl. 382/103; 382/182

(57) ABSTRACT

Disclosed is a method of extracting a text area, the method including generating a text area prediction value within an input second image based on a plurality of text area data stored in a database including geometric information about a text area of a first image, generating a text recognition result value by determining whether a text is recognized with respect to a probable text area within the input second image, and selecting a text area within the second image by combining the generated text area prediction value and text recognition result value.

### CROSS-REFERENCE TO RELATED APPLICATIONS

This application claims priority to and the benefit of Korean Patent Application No. 10-2010-0127723 filed in the Korean Intellectual Property Office on Dec. 14, 2010, the entire contents of which are incorporated herein by reference.

### TECHNICAL FIELD

The present invention relates to a method and an apparatus for extracting a text area of a character, a number, and the like, from an image photographed from an external nature image, and an automatic number plate recognition system using the same.

### BACKGROUND

In general, an automatic number plate recognition system using an image of a camera includes three parts. (1) First, a number plate area of a vehicle and the like is detected from an external nature image. (2) Next, a text area of a character, a number, and the like is extracted from the detected number plate area. (3) Finally, a character, a number, and the like corresponding to a detected text are identified.

With respect to a configuration of extracting the text area of the number, the character, and the like among the above processes, a conventional text area extraction method representatively employs a technology of separating a text positioned area by (i) performing binarization with respect to a number plate image and (ii) removing a noise area through a connected component analysis, and the like.

The conventional method reliably operates when the number plate image is clean and has a high resolution, however, has difficulty in separating a character area through binarization when a resolution of an image is low, or when a foreign substance and the like are attached to the number plate. Also, due to image noise, adjacent number areas may overlap each other and thereby be merged. Even though it is a single number area, the number area may be separated.

That is, even though it is possible to increase the extraction performance of a character area through local binarization of performing binarization by dividing an area in an image, a morphology operation of increasing or reducing a binary area, and the like, there are some constraints.

### SUMMARY

The present invention has been made in an effort to provide a method of extracting a text area from a number plate image and the like, and particularly, a method of more accurately extracting a text such as a character, a number, and the like from a number plate image having a relatively low resolution or having great noise by extracting a text area using prediction information based on text recognition information and a database storing text position and size information of a number plate.

An exemplary embodiment of the present invention provides a method of extracting a text area, including: generating a text area prediction value within an input second image based on a plurality of text area data stored in a database including geometric information about a text area of a first image; generating a text recognition result value by determining whether a text is recognized with respect to a probable text area within the input second image; and selecting a text area within the second image by combining the generated text area prediction value and text recognition result value.

The geometric information may include position and size information of the text area, and the generating of the text area prediction value may generate the prediction value based on similarity with N text area data stored in the database including the position and size information of the text area. The text may be meaningful visual information including at least one of a character, a number, a symbol, and a sign.

The position and size information about the text area of the first image pre-stored in the database and the generated text recognition result value may be learning information that is repeatedly used to select the text area within the second image.

The database may include the position and size information about the text area of the first image in a form of numerical value information that is converted into a vector format.

The vector format may be a format that includes an absolute value with respect to the text area or a positional relative value with another text area.

The generating of the text area prediction value may further include generating a missing value estimate by predicting a missing value of the text area based on the database and text extraction information from the second image; and generating a first score map storing an estimation probability about the missing value estimate based on all of the predicted missing value estimates.

The generating of the text recognition result value may recognize whether the text exists with respect to all areas within the second image, and an absolute value or a relative value with respect to the text area may include all of the horizontal and vertical position values within the second image and include minimum to maximum sizes of a width and a height of the text area.

The generating of the text recognition result value may further include generating a second score map storing an estimation probability of whether the recognized text exists.

The selecting of the text area may further include generating a third score map merged by adding the same standard of the generated first score map and second score map, and the selecting of the text area may select a text area having the highest score in the generated third score map.

The selecting of the text area may exclude the text area having the highest score in the generated third score map from selectable text area candidates when the text area having the highest score in the generated third score map overlaps an area selected as another text area by at least a predetermined range.

After the selecting of the text area, the text area extraction method may further include determining whether a text area extraction operation within the second image is completed by repeatedly performing the text area extraction method.

The second image may be an image of a notice plate, and the determining of whether the text area extraction operation is completed may compare the number of the extracted text areas according to a notice plate indication standard of each country.

Another exemplary embodiment of the present invention provides an apparatus for extracting a text area, including: a database to include geometric information about a text area of a first image; a missing value predicting unit to generate a missing value estimate by predicting a missing value of a text area within an input second image based on a plurality of text area data stored in the database; a first score map generating unit to generate a first score map storing an estimation probability about the missing value estimate based on the predicted missing value estimate; a text recognition unit to generate a text recognition result value by determining whether a text is recognized with respect to a probable text area within the input second image; a second score map generating unit to generate a second score map storing an estimation probability of whether the recognized text exists; and a text area selecting unit to select the text area within the second image by combining the generated first score map and second score map.

Yet another exemplary embodiment of the present invention provides an automatic number plate recognition system, including: a number plate detecting unit to detect a number plate image from an external image photographed using a camera; a text area extracting unit to generate a text area prediction value within the detected number plate image based on a database including geometric information about a text area within a pre-stored number plate image, to generate a text recognition result value by determining whether a text is recognized with respect to a probable text area within the number plate image, and to select a text area within the number plate image by combining the generated text area prediction value and text recognition result value; and a text identifying unit to identify a text indicated within the extracted text area.

The present invention provides computer readable recording media storing a program to implement the method of extracting the text area.

According to exemplary embodiments of the present invention, by repeatedly employing a database storing position and size information of a character area of a number plate and a result of a character recognition unit, it is possible to solve a disadvantage, which is found in a conventional character area extraction method using an image processing algorithm, that a character area is not accurately extracted from an image having a low resolution or noise.

According to exemplary embodiments of the present invention, a text area extracting apparatus operates based on learning information such as (1) a character area database and (2) a character recognition unit. Therefore, when a different number plate is to be recognized for each country, the character area extracting unit may be immediately applied by replacing learning information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart to describe a method of extracting a text area according to an exemplary embodiment of the present invention.

FIG. 2 is an exemplary diagram modeling position and size information of a text area according to an exemplary embodiment of the present invention.

FIG. 3 is a diagram illustrating a process of determining whether a text is recognized with respect to a probable text inspection area according to an exemplary embodiment of the present invention.

FIG. 4 is a flowchart to describe in detail a method of extracting a text area according to an exemplary embodiment of the present invention.

FIG. 5 is a functional block diagram illustrating an apparatus for extracting a text area according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereafter, exemplary embodiments of the present invention will be described in detail with reference to the accompanying drawings. First of all, it is to be noted that in giving reference numerals to elements of each drawing, like reference numerals refer to like elements even though like elements are shown in different drawings. Further, when it is determined that the detailed description related to a known configuration or function may render the purpose of the present invention unnecessarily ambiguous in describing the present invention, the detailed description will be omitted here. Further, the exemplary embodiments of the present invention will be described hereinbelow, but it will be apparent to those skilled in the art that various modifications and changes may be made thereto without departing from the scope and spirit of the invention.

When describing constituent elements of the present invention, terms such as first, second, A, B, (a), (b), and the like, may be used. Such term may be used to distinguish a corresponding constituent element from other constituent elements and thus, a property, a sequence, an order, and the like of the corresponding constituent element is not limited to the term. When a predetermined constituent element is described to be “connected to”, “combined with”, or “accessed by” another constituent element in the description, it indicates that the constituent element may be directly connected to or accessed by the other constituent element. However, it may also be understood that still another constituent element may be “connected”, “combined”, or “accessed” between constituent elements.

The present invention proposes a method of extracting a text area in which a character, a number, and the like is indicated, from a photographed number plate image during an operation process of an automatic number plate recognition system. The method may extract an area where a text such as a character, a number, and the like is indicated, at high accuracy even with respect to a number plate image having a low resolution or noise, by combining (1) a text area position prediction result based on a database storing position and size information of a text area such as a character, a number, and the like, with (2) a recognition result value of a text recognition unit, and thereby extract the text area within a number plate image.

For example, depending on circumstances, a number plate may be partially or overall indented. In this case, an image correction may be performed to a crushed portion to some extent, however, accuracy decreases in identifying whether a corresponding character is 5 or 8 using image correction processing that is additionally performed for a photographed image. Accordingly, the present invention provides a method that enables a system to finally and accurately identify a character by accurately extracting an area of a character, a number, and the like indicated on a number plate.

A text that is to be extracted and be identified in the present invention corresponds to a character, a number, a symbol, a sign, or combination thereof and indicates meaningful visual information. Even though the text area is described as a “character area” in the following, it is only an embodiment of an area of the text and is assumed to include a number or other visual information.

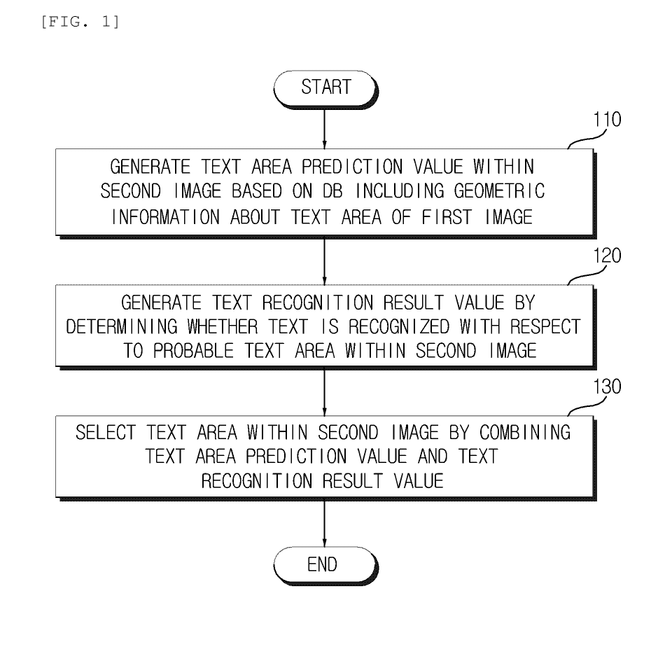

FIG. 1 is a flowchart to describe a method of extracting a text area according to an exemplary embodiment of the present invention.

The exemplary embodiment of the present invention performs a method of extracting a text area by including operation 110 of generating a text area prediction value within a second image based on a plurality of text area data stored in a database including geometric information about a text area of a first image, operation 120 of generating a text recognition result value by determining whether a text is recognized with respect to a probable text area within the input second image, and operation 130 of selecting a text area within the second image by combining the generated text area prediction value and text recognition result value.

For example, when extracting a test area of a number plate of a vehicle, the first image may be a photographed image of a number plate of another vehicle. When constructing, as a database, geometric information such as positions and sizes of character areas and the like about characters indicated in a plurality of number plate images, it is possible to generate a character area prediction value within a currently input number plate image using a similar form of character area data stored in the database.

That is, in operation 110, the database storing character area data is used and position and size information of character areas is estimated from a newly input number plate image using similarity of geometric information constituted by character areas of number plates.

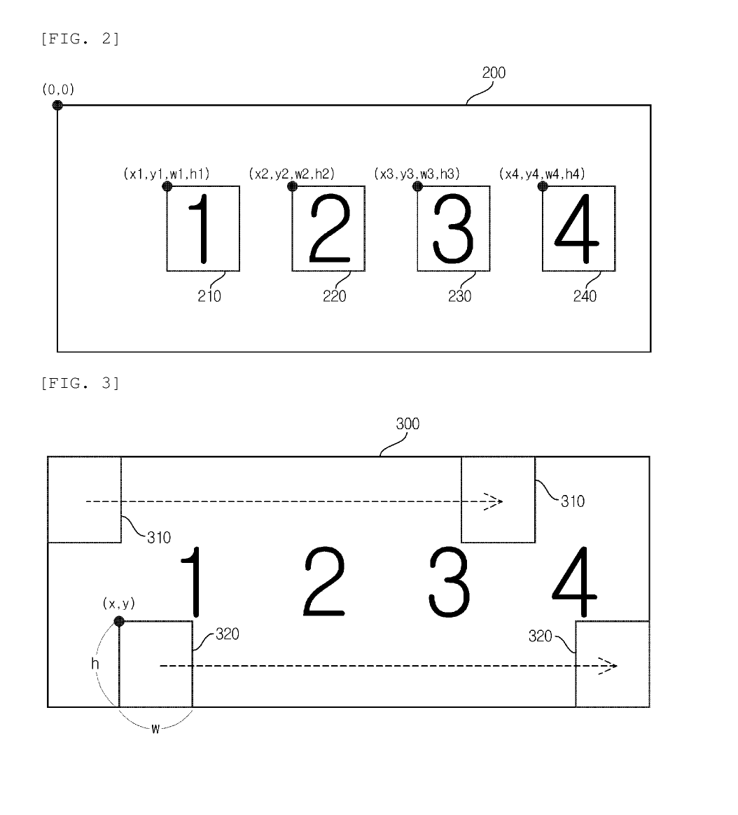

For this, the aforementioned database needs to be constructed. Therefore, the database storing position and size information of character areas is generated using N number plate images and position and size information of the character areas. Here, for database generation, character position and size information of a number plate image needs to be converted into a numerical value format, which is advantageous for a missing value prediction to be performed in the following operation. An example of the conversion into a numerical value will be described with reference to FIG. 2.

FIG. 2 is an exemplary diagram modeling position and size information of a text area according to an exemplary embodiment of the present invention.

Referring to FIG. 2, each of numbers 210, 220, 230, and 240 within a number plate image 200 has position and size information within the current number plate image 200. For example, when coordinates of an upper leftmost point of the number plate image 200 are (0, 0), a position of a first number 210 “1” is (x1, y1) and a size (width and height) thereof is (w1, h1). Similarly, each of the remaining numbers 220 to 240 has position and size information.

A plurality of text area data in the above form is stored in the aforementioned database and is stored in a vector format. Here, as the simplest method, the vector format may be expressed as a 16-order vector such as (x1, y1, w1, h1, x2, y2, w2, h2, x3, y3, w3, h3, x4, y4, w4, h4) by simply adding information of each character. As another method, when expressing a position of each character, it is possible to record a position difference with a previous character. That is, it is possible to express the vector format like (x1, y1, w1, h1, x2-x1, y2-y1, w2, h2, x3-x2, y3-y2, w3, h3, x4-x3, y4-y3, w4, h4). That is, the database has position and size information about the character area as numerical value information that is converted into the vector format.

When using a vector as above, the vector may further affect positional correlation of each of the characters within a number plate image may be further affected, rather than absolute positions of the characters. Therefore, when performing prediction by employing one character position among a total of four characters as a missing value like the above example, it is possible to obtain a more accurate result.

Meanwhile, the vector expression method is only an example for description and thus, a position and size information vector may be configured using another method. The number of characters may vary based on a type of a number plate to be identified.

As described above in the database construction process, one number plate image is indicated as one vector after undergoing a process of conversion into a position and size vector of a character area. When N number plates are to be learned, a total of N vectors are stored in the database.

Describing again operation 110 of FIG. 1, a missing value prediction is performed based on the database generated as above and character extraction information from the currently input number plate image. When using again the 16-order vector used in the above example, for example, when positions of the first character, the second character, and the fourth character are known, it is possible to estimate position and size information of the third character using a missing value prediction method.

As one example of a method that can be readily used as the missing value prediction method, a vector to find a missing value may compare information about an order, not the missing value, with character area data of the database, take information of an order corresponding to the missing value from instances having a small Euclidean distance, and thereby use the information as an estimate of the missing value. That is, a similar instance is taken from the database based on character information that is known in the current number plate image and thereby is used to estimate the missing value.

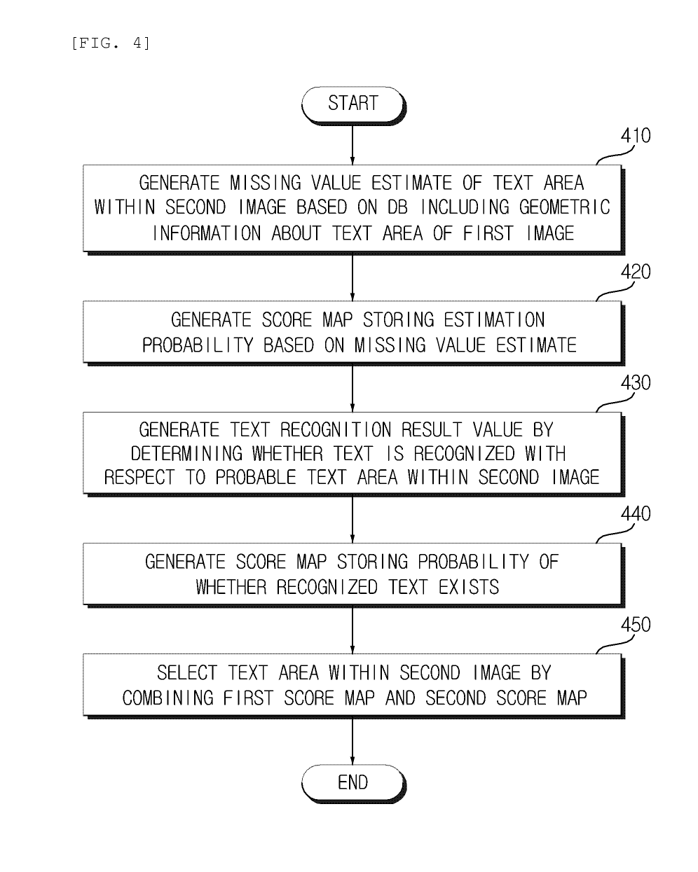

In operation 120, a text character recognition result value is generated by designating a character inspection area and determining whether a character is recognized. It will be described with reference to FIG. 3.

FIG. 3 is a diagram illustrating a process of determining whether a text is recognized with respect to a probable text inspection area according to an exemplary embodiment of the present invention.

A character inspection area within a number plate image 300 includes, for example, coordinates (x, y) of an upper leftmost point and a horizontal and vertical length, that is, a width and a height (w, h) of the inspection area. A character area needs to be extracted by performing character recognition with respect to all of the probable inspection areas within the number plate image 300. Therefore, x and y may be all points within the number plate image 300 and the range of w and h may be from the minimum size of a character to the maximum size of the character.

Whether a character is recognized may be determined with respect to the character inspection area set as above. Windows of character inspection areas 310 and 320 set in FIG. 3 may perform a scanning operation with respect to all the inspection areas of the number plate image 300.

In operation 130 of FIG. 1, a text area is selected within the number plate image by combining the character area prediction value and the character recognition result value.

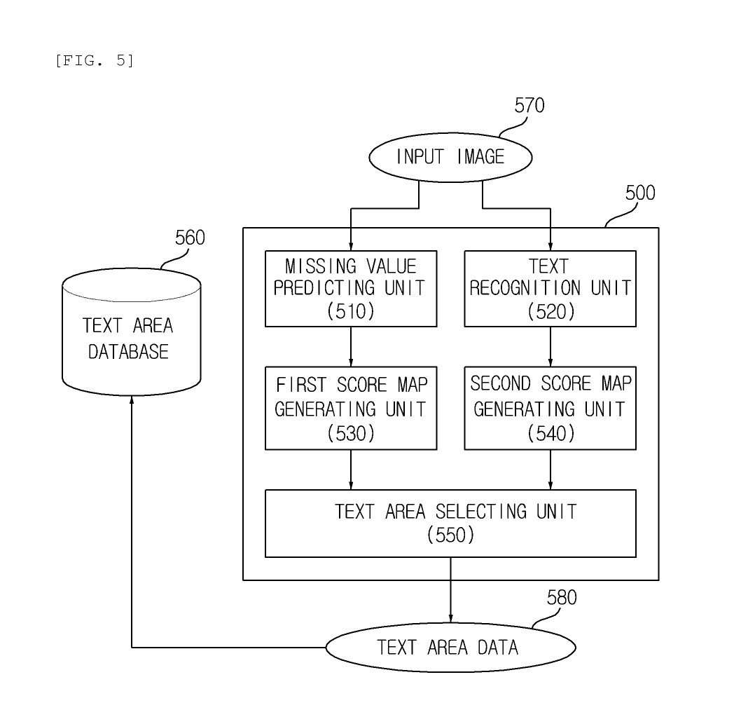

FIG. 4 is a flowchart to describe in detail a method of extracting a text area according to an exemplary embodiment of the present invention. For this, it will be described with reference to a functional block diagram indicating a text area extraction apparatus 500 of FIG. 5.

An exemplary embodiment of the text area extraction apparatus 500 includes a text area database 560 to include geometric information about a text area of an image, a missing value predicting unit 510 to generate a missing value estimate by predicting a missing value of a text area within a newly input image 570 based on a plurality of text area data stored in the database 560, a first score map generating unit 530 to generate a first score map storing an estimation probability about the missing value estimate based on the predicted missing value estimate, a text recognition unit 520 to generate a text recognition result value by determining whether a text is recognized with respect to a probable text area within an input second image, a second score map generating unit 540 to generate a second score map storing an estimation probability of whether the recognized text exists, and a text area selecting unit 550 to select the text area within the second image by combining the generated first score map and second score map and thereby output text area data 580.

When describing the character area extraction method with reference to FIG. 4, operation 410 uses a database storing character area data, in the same manner as operation 110 of FIG. 1, and estimates position and size information of character areas in a newly input number plate image using similarity of geometric information constituted by character areas of number plates. That is, a missing value prediction is performed based on the database and character extraction information from the current input number plate image.

In operation 420, the first score map storing the estimation probability about the missing value estimate is generated based on all the predicated missing value estimates.

For example, when a position and a size of the third character among four characters indicated in an image is a missing value, a value of (x3, y3, w3, h3) becomes the missing value and a score map is generated based on an estimate about the missing value. Here, a score value is calculated with respect to all values of a four-order vector. Although it may be different based on a method of estimating the missing value, the estimation probability exists with respect to all the missing values. One missing value having the largest estimation probability may be used as the missing value estimate.

In the exemplary embodiment of FIG. 4, the first score map is generated by storing the estimation probability with respect to all the missing values as is instead of using a single estimate. Next, the generated first score map may be added with the second score map generated in operation 440.

In operation 430, the character recognition result value is generated by designating the character inspection area and determining whether the character is recognized. As described above, the character inspection area within the number plate image 300 may include, for example, coordinates (x, y) of an upper leftmost point and width and height (w, h) of the inspection area, and the character area needs to be extracted by performing character recognition with respect to all of the probable inspection areas within the number plate image. Therefore, x and y may be all points within the number plate image 300 and the range of w and h may be from the minimum size of a character to the maximum size of the character.

In operation 440, a probability that a corresponding area may be a character may be calculated by performing character recognition with respect to each of all the inspection areas. A method such as artificial neural networks, self-organizing map, and the like may be used as a method of recognizing whether the corresponding area is a character. The score map storing the estimation probability about the existence of the character is generated.

In operation 450, a text area within the number plate image is selected by combining the character area estimate and the character recognition result value. Specifically, a single score map is generated by combining the score maps generated in operations 420 and 440. Two score maps follow the same standard having a score value with respect to (x, y, w, h) and thus, may be combined through a simple summation or a weighted sum.

Character area information (x, y, w, h) having the highest score value based on the calculated single score map is selected as character area data.

Here, when a character area having the highest score in the single score map overlaps an area selected as a subsequent character area by at least a predetermined range, the character area may be excluded from selectable character area candidates.

In the meantime, although not shown in FIG. 4, an operation of determining whether a character area extraction operation within the number plate image is completed by repeatedly performing the text area extraction method may be further included. That is, whether the character area extraction operation is terminated is verified based on character area information selected so far.

Whether the character area extraction operation is terminated through comparison is determined based on advance information such as the number of character areas and the like corresponding to each country. For example, in the European countries, a number plate has a combined area using seven characters and numbers. Therefore, when seven character areas are selected, the character area extraction operation is terminated.

When describing an automatic number plate recognition system using the text area extraction apparatus of FIG. 5, the automatic number plate recognition system includes a number plate detecting unit to detect a number plate image from an external image photographed using a camera. The number plate detecting unit extracts a number plate area from the external nature image to transfer a number plate image to a text area extracting unit. It is assumed that if the number plate occurring is indented while taken in a photographing direction of the camera, it is corrected in the transferred number plate image.

The automatic number plate recognition system includes a text area extracting unit to generate a text area prediction value within the detected number plate image based on a database including geometric information about a text area within a pre-stored number plate image, to generate a text recognition result value by determining whether a text is recognized with respect to a probable text area within the number plate image, and to select a text area within the number plate image by combining the generated text area prediction value and text recognition result value, and a text identifying unit to identify a text indicated within the extracted text area.

In the meantime, position and size information about the text area of the number plate image pre-stored in the database and the text recognition result value are learning information that is repeatedly used to select the text area within the number plate image. Accordingly, when a different number plate is to be recognized for each country, the automatic number plate recognition system may be immediately applied by replacing the learning information.

The present invention includes recording media storing a program to implement the text area extraction method.

Examples of computer readable recording media include ROM, RAM, CD-ROM, magnetic tapes, floppy disks, optical data storage devices, and the like. Computer readable recording media may be distributed to a computer system connected over a network whereby a code that can be read by a computer using a distribution scheme may be stored and be executed.

Functional programs, codes, and code segments to embody the present invention can be easily inferred by programmers in the technical field of the present invention.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Also, unless defined otherwise, the terms “comprises”, “comprising”, “includes”, “including”, and the like used herein indicates that a corresponding constituent element may be included and thus, should be understood to further include another constituent element, not precluding the other constituent element. Unless otherwise defined, all terms including technical and scientific terms used herein have the same meaning as commonly understood by one of ordinary skill in the art to which the present invention belongs. It will be further understood that terms, such as those defined in commonly used dictionaries, should be interpreted has having a meaning that is consistent with their meaning in the context of the relevant art and should not be interpreted in an idealized or overly formal sense unless expressly so defined herein.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of extracting a text area, comprising:
generating a text area prediction value within an input second image based on a plurality of text area data stored in a database including geometric information about a text area of a first image;
generating a text recognition result value by determining whether a text is recognized with respect to a probable text area within the input second image; and
selecting a text area within the second image by combining the generated text area prediction value and text recognition result value.

2. The method of claim 1, wherein:
the geometric information includes position and size information of the text area, and
the generating of the text area prediction value generates the prediction value based on similarity with N text area data stored in the database including the position and size information of the text area, N indicating a positive integer equal to or greater than 1.

3. The method of claim 2, wherein the text is meaningful visual information including at least one of a character, a number, a symbol, and a sign.

4. The method of claim 3, wherein the position and size information about the text area of the first image pre-stored in the database and the generated text recognition result value are learning information that is repeatedly used to select the text area within the second image.

5. The method of claim 2, wherein the database includes the position and size information about the text area of the first image in a form of numerical value information that is converted into a vector format.

6. The method of claim 5, wherein the vector format is a format that includes an absolute value with respect to the text area or a positional relative value with another text area.

7. The method of claim 6, wherein the generating of the text area prediction value further comprises:
generating a missing value estimate by predicting a missing value of the text area based on the database and text extraction information from the second image; and
generating a first score map storing an estimation probability about the missing value estimate based on all of the predicted missing value estimates.

8. The method of claim 7, wherein:
the generating of the text recognition result value recognizes whether the text exists with respect to all areas within the second image, and
an absolute value or a relative value with respect to the text area includes all of the horizontal and vertical position values within the second image and includes minimum to maximum sizes of a width and a height of the text area.

9. The method of claim 8, wherein the generating of the text recognition result value further comprises:
generating a second score map storing an estimation probability of whether the recognized text exists.

10. The method of claim 9, wherein the selecting of the text area further comprises:
generating a third score map merged by adding the same standard of the generated first score map and second score map, and
the selecting of the text area selects a text area having the highest score in the generated third score map.

11. The method of claim 10, wherein the selecting of the text area excludes the text area having the highest score in the generated third score map from selectable text area candidates when the text area having the highest score in the generated third score map overlaps an area selected as another text area by at least a predetermined range.

12. The method of claim 1, after the selecting of the text area, further comprising:
determining whether a text area extraction operation within the second image is completed by repeatedly performing the text area extraction method.

13. The method of claim 12, wherein the second image is an image of a notice plate, and
the determining of whether the text area extraction operation is completed compares the number of the extracted text areas according to a notice plate indication standard of each country.

14. An apparatus for extracting a text area, comprising:
a database to include geometric information about a text area of a first image;
a missing value predicting unit to generate a missing value estimate by predicting a missing value of a text area within an input second image based on a plurality of text area data stored in the database;
a first score map generating unit to generate a first score map storing an estimation probability about the missing value estimate based on the predicted missing value estimate;
a text recognition unit to generate a text recognition result value by determining whether a text is recognized with respect to a probable text area within the input second image;
a second score map generating unit to generate a second score map storing an estimation probability of whether the recognized text exists; and
a text area selecting unit to select the text area within the second image by combining the generated first score map and second score map.

15. An automatic number plate recognition system, comprising:
a number plate detecting unit to detect a number plate image from an external image photographed using a camera;
a text area extracting unit to generate a text area prediction value within the detected number plate image based on a database including geometric information about a text area within a pre-stored number plate image, to generate a text recognition result value by determining whether a text is recognized with respect to a probable text area within the number plate image, and to select a text area within the number plate image by combining the generated text area prediction value and text recognition result value; and
a text identifying unit to identify a text indicated within the extracted text area.
